(19) United States
(12) Patent Application Publication
(10) Pub. No.: US 2018/0141151 A1
(43) Pub. Date: May 24, 2018

(54) METHOD AND APPARATUS FOR METAL THREE-DIMENSIONAL PRINTING

(71) Applicant: Fupeng Liang, Shanghai (CN)

(72) Inventors: Fupeng Liang, Shanghai (CN); Chaobao Luo, GuangxiZhuang Autonomous Region (CN)

(21) Appl. No.: 15/667,263

(22) Filed: Aug. 2, 2017

(30) Foreign Application Priority Data
Jun. 3, 2016 (CN) 201610392153.4

(51) Int. Cl. B23K 11/00; B33Y 10/00; B33Y 30/00; B33Y 50/02

(52) U.S. Cl. CPC B23K 11/0013; B33Y 50/02; B33Y 30/00; B33Y 10/00

(57) ABSTRACT

The invention discloses a method and an apparatus for metal three-dimensional printing, in which the method for metal three-dimensional printing comprises the following steps: molten or softened flowable metal is placed in a build area used by a three-dimensional printing device, after having no fluidity, the molten or softened flowable metal is converted into metal built by printing, the molten or softened flowable metal is accumulated on the basis of the metal built by printing, until an object to be printed is built, and the accumulated metal built by printing forms the object to be printed; the key characteristics are as follows: in the building process, the interlayer binding force and the binding force between pixel points are changed through a manner of resistance heating; and a printing area for implementing resistance heating can be set. The metal component generated has high strength, high density, and high building precision, the building process of each pixel point is monitored, a removable auxiliary support can be generated synchronously, a large-scale component can be printed, and the apparatus is simple in structure and low in cost. The present invention possesses a substantial progress.

### FIELD OF THE INVENTION

The present invention relates to the technology of three-dimensional printing, in particular to a method and an apparatus for metal three-dimensional printing, belonging to the technical field of additive manufacturing.

### BACKGROUND OF THE INVENTION

Three-dimensional printing technology firstly originated in the U.S. at the end of the 19^{th} century, and was perfected and commercialized in Japan and the U.S. in the 1970s and 1980s. The mainstream three-dimensional printing technologies commonly seen now, such as Stereo Lithography Apparatus (SLA), Fused Deposition Modeling (FDM), Selecting Laser Sintering (SLS) and Three Dimensional Printing and Gluing (3DP), were commercialized in the U.S. in the 1980s and the 1990s. The currently-commercialized technologies used for metal material three-dimensional printing mainly include Selective Laser Melting (SLM) and Electron Beam Melting (EBM), however, the SLM and EBM technologies also have such shortcomings as high manufacturing cost, high maintenance cost, low mechanical strength of the printed components (in particular, an enhancement process is needed after printing in the SLM technology) and small printing format. In order to improve the material density of metal components printed by the SLM and EBM technologies, other technologies emerged, including a Chinese patent application with an application number of 201410289871.X and entitled “Processing Method for Improving Performance of Metal Parts through 3D Printing”. In view of the shortcomings of the above SLM and EMB technologies, other low-cost metal 3D printing technologies utilizing other building methods also appeared, such as a Chinese patent application with an application number of 201510789205.7 and entitled “Method and Device for 3D Printing and Manufacturing Directly by Utilizing Liquid Metal”, a Chinese patent application with an application number of 201510679764.2 and entitled “Rapid Building Device for Metal 3D Printing”, and a Chinese patent application with an application number of 201410206527.X and entitled “Extruding-type Metal Flow 3D Printer”, however, these technologies have the shortcomings of low building precision or low interlayer binding force between the metal layers built by printing.

### SUMMARY OF THE INVENTION

An objective of the present invention is to provide a method and an apparatus for metal three-dimensional printing with high printing precision, strong interlayer binding force and low cost.

Another objective of the present invention is to provide a method for synchronously printing a removable auxiliary support while printing a metal component as required.

Still another objective of the present invention is to provide a method for monitoring whether a printed metal pixel point is valid or not in real time in the printing process, namely, to monitor in real time whether a metal point is generated in a position corresponding to a pixel point required to be printed.

To realize the above objectives, the present invention adopts the following technical solution: a method for metal three-dimensional printing, comprising a main process as follows: molten or softened flowable metal is placed in a build area (forming area or forming space) used by a three-dimensional printing apparatus, after having no fluidity, the molten or softened flowable metal is converted into metal built by printing, the molten or softened flowable metal is accumulated on the basis of the metal built by printing, until an object to be printed is built and the accumulated metal built (formed) by printing forms the object to be printed, wherein in a process of accumulating the molten or softened flowable metal, the position where the molten or softened flowable metal is placed is determined by the shape and the structure of the object to be printed; the build area used by the three-dimensional printing apparatus refers to the space used by the three-dimensional printing apparatus when an object is printed; the molten or softened flowable metal is referred to as metal A, and the metal built by printing is referred to as metal B;

characterized in that

in a process of accumulating metal A, a current is applied between (or through) metal A and metal B, by way of resistance heating, the part of metal B, which is in contact with metal A, is molten;

or, in a process of accumulating metal A, a current is applied between metal A and metal B, by way of resistance heating, the part of metal B, which is in contact with metal A, has a raised temperature but is not molten;

or, in a portion of a printing area, in a process of accumulating metal A, a current is applied between metal A and metal B, by way of resistance heating, the part of metal B, which is in contact with metal A, is molten; in a portion of a printing area, in a process of accumulating metal A, a current is applied between metal A and metal B, by way of resistance heating, the part of metal B, which is in contact with metal A, has a raised temperature but is not molten;

or, in a portion of a printing area, in a process of accumulating metal A, a current is applied between metal A and metal B, by way of resistance heating, the part of metal B, which is in contact with metal A, is molten; in a portion of a printing area, in a process of accumulating metal A, a current is applied between metal A and metal B, by way of resistance heating, the part of metal B, which is in contact with metal A, has a raised temperature but is not molten; in a portion of a printing area, in a process of accumulating metal A, no current is applied between metal A and metal B;

or, in a portion of a printing area, in a process of accumulating metal A, a current is applied between metal A and metal B, by way of resistance heating, the part of metal B, which is in contact with metal A, is molten; in a portion of a printing area, in a process of accumulating metal A, no current is applied between metal A and metal B;

or, in a portion of a printing area, in the processing of accumulating metal A, a current is applied between metal A and metal B, by way of resistance heating, the part of metal B, which is in contact with metal A, has a raised temperature but is not molten; in a portion of a printing area, in a process of accumulating metal A, no current is applied between metal A and metal B;

the portion of a printing area refers to a portion of the space to be occupied by metal A and metal B in a process of printing an object. The portion of a printing area can also be understood as a portion of a mapping space, which is formed when the to-be-printed object is mapped to the build area used by the three-dimensional printing apparatus. The portion of a printing area can also be understood as follows: the space to be occupied by the to-be-printed object is divided out in advance, a virtual object in mapping relationship with the to-be-printed object is formed, the virtual object is gradually converted into a real object which is finally built by printing, and the process in which the virtual object is converted into a real object is just a process of three-dimensional building by printing; and the virtual object is divided into a plurality of areas, and a portion of the area therein is just the so-called a portion of a printing area.

In a preferred embodiment, the to-be-printed object is a target component, or is composed of a target component and an auxiliary support. The target component is the component to be printed by the user; the auxiliary support is an auxiliary structure, and is removed by the user after the three-dimensional printing is finished.

In a preferred embodiment:

the position where metal A is in contact with metal B is controlled by a computer; and the current applied between metal A and metal B is controlled by the computer;

the object to be printed is generated by superimposing layers, namely, the object to be printed is generated through the superposition of the object layer by layer, the number of the layer or layers is at least one; each layer is composed of pixel points, and the thickness of the layer is determined by the height of the pixel points;

Metal A is flowable, and whether metal A flows or not is controlled by the computer; in the printing process, metal A exists in a form of metal flow; after the front part of the metal flow is in contact with metal B and connected to metal B, the temperature of the front part of the metal flow is lowered, and the front part of the metal flow is converted into metal B automatically to form pixel points; and the number of the metal flow or metal flows is at least one. The lowered temperature of the front part of the metal flow is due to the fact that the heat in the front part of the metal flow is guided away by a medium, for example, metal B accumulated previously or a printing support platform of the three-dimensional printing apparatus, if the process of building by printing is performed in a non-vacuum environment, then gases in the environment will also guide away a part of the heat.

In a preferred embodiment:

In the printing process, metal B is supported by a support layer, namely, the support layer serves as a basis for printing the first layer;

there are some three-dimensional building steps from the first layer to the last layer as follows:

step S1, beginning to print the first layer, under the control of the computer, metal A is in contact with a position on the support layer, corresponding to the first pixel point in a to-be-printed pixel queue generated by the computer of the first layer; and a bottom surface of the first layer is coplanar with an upper surface of the support layer;

step S2, applying or not applying a current between metal A and the support layer based on parameters set by the user and/or generated by computing with the aid of the computer; if a current is applied, the intensity of the current can be controlled by the computer;

step S3, judging whether the printing of the first layer has been completed or not with the aid of the computer, if the printing of the first layer has not been completed, the position where metal A is in contact with the support layer is set to be the position corresponding to the next pixel point, metal A and the support layer are in contact with each other, then step S2 to step S3 are repeated; if the printing of the first layer has been completed, and a next layer needs to be printed, then the printing process proceeds to step S4; if a next layer does not need to be printed, the printing process is finished;

step S4, beginning to print a new layer, under the control of the computer, metal A is in contact with a position on the layer previously built by printing, corresponding to the first pixel point in a to-be-printed pixel queue generated by the computer of the current layer; and a bottom surface of the current layer being printed is coplanar with an upper surface of the layer previously built by printing;

step S5, applying or not applying a current between metal A and metal B based on parameters set by the user and/or generated by computing with the aid of the compute; if a current is applied, the intensity of the current can be controlled by the computer;

step S6, judging whether the printing of the current layer has been completed or not with the aid of the computer, if the printing of the current layer has not been completed, the position where metal A is in contact with metal B is set to be the position corresponding to the next pixel point, metal A and metal B are in contact with each other, then step S5 to step S6 are repeated; if the printing of the current layer has been completed and a next layer needs to be printed, then the printing process proceeds to step S7; if a next layer does not need to be printed, the printing process is finished;

step S7, repeating step S4 to step S6 until the printing process is finished.

The above support layer can be a support platform, and can also be a layered structure fixed on the support platform, and the layered structure refers to a plate fixed on the support platform, or a support, or a powder layer paved on the support platform, for example, a metal plate, or a metal support, or a metal powder layer.

In a preferred embodiment, in step S2 and step S5 in the three-dimensional building steps from the first layer to the last layer, the parameters generated by computing is generated by the computer in the following two cases:

Case 1, based on the shape and the structure of a target component (the component to be printed), a removable auxiliary printed body (e.g., an auxiliary support generated synchronously with the target component) is automatically generated with the aid of the computer. For the convenience of removing, for the building process of most pixel points of the removable auxiliary printed body, no resistance heating is required for enhancing the structural strength thereof; and all the pixel points, which do not need resistance heating to enhance the structural strength thereof, of the removable auxiliary printed body are all labeled with the parameters indicating that no current needs to be applied;

Case 2, for the building process of all the pixel points in the entity area of the target component, resistance heating is required to enhance the structural strength thereof, and all the pixel points in the entity area of the target component are labeled with the parameters indicating that the current needs to be applied.

In a preferred embodiment, the portion of a printing area is mainly determined by the shape of the component to be printed, and/or set by the user, or determined by the algorithm optimized by the computer. For example, when the first layer is printed, in order to conveniently fix the component to be printed on the support layer, but in order to conveniently remove the component printed from the support layer, in some printing areas (such as four equal division points on the contour line of the first layer), a current needs to be applied between metal A and the support layer to enhance the connection between the two, while in other printing areas of the first layer, no current needs to be applied between metal A and the support layer, so as to prevent a too strong binding force between the component to be printed and the support layer, the too strong binding force will make it difficult to remove the component printed from the support layer.

In a preferred embodiment, the portion of a printing area is mainly divided into an area with a high building strength and an area with a low building strength. For example, all the layers of the target component are set to be areas with a high building strength, and the areas with a high building strength are connected to each other and built in a molten manner (namely, the strength of the resistance heating is sufficient to melt the position where metal B is in contact with metal A); all the layers of such auxiliary structures as the support body are set to be areas with a low building strength, and no current needs to be applied in the building process of the areas with a low building strength.

In a preferred embodiment, the portion of a printing area is mainly divided into an area with a high building strength, an area with a medium building strength and an area with a low building strength. For example, the corresponding areas requiring a high building strength of all the layers of the target component are set to be areas with a high building strength, the corresponding areas requiring a medium building strength of all the layers of the target component are set to be areas with a medium building strength, all the layers of such auxiliary structures as the support body are set to be areas with a low building strength, and the intensity of the current needs to be applied to each type of such printing areas can be set; wherein in the case that no current needs to be applied, the intensity of the current can be regarded as zero.

In a preferred embodiment:

the molten or softened degree of metal A is adjustable, which can be realized through adjusting the temperature of metal A and is controlled by the computer; the flow speed and the flow rate in unit time of metal A are adjustable, can be realized through adjusting the level of the extrusion pressure applied to metal A, and are controlled by the computer.

In a preferred embodiment, before metal A is in contact with metal B, the area of metal B, which is to be in contact with metal A, is preheated; a plurality of preheating ways are available, such as high-temperature plasma heating, electric arc heating, high-frequency electromagnetic induction heating and laser heating.

In a preferred embodiment, a current is applied between metal A and metal B only after it is monitored that metal A is in contact with metal B.

In a preferred embodiment, the contact manner between metal A and metal B is point dipping or dragging; in the manner of point dipping, metal A is lifted up after being in contact with and connected to metal B at a position corresponding to a pixel point, a part of metal A is adhered with metal B and left on metal B, the other part of metal A is separated from metal B and is in contact with metal B again when the next pixel point is printed; in the manner of dragging, in the printing process, metal A exists in a form of metal flow, in the area to be printed, the metal flow moves relative to metal B and at the same time remains in contact with metal B, after being in contact with and connected to metal B, the front part of the metal flow is automatically converted into metal B, and then pixel points are formed, the subsequent metal flow is in contact with a position corresponding to a pixel point to be printed and is continuously converted into metal B, until the printing process is finished or suspended.

In a preferred embodiment, metal A adopts a metal slurry. The metal slurry is a type of paste suitable for printing or coating which is composed of metal powder, additives and organic carriers. The metal slurry is widely used in the electronics industry.

Furthermore, the present invention provides an apparatus for metal three-dimensional printing for printing a metal component by utilizing the above method for metal three-dimensional printing, with the technical solution as follows: an apparatus for metal three-dimensional printing, characterized in that it comprises a heating unit used for generating molten or softened flowable metal (or used for melting or softening metal into a flowable state), a position driving mechanism used for controlling the contact position between the molten or softened flowable metal and the metal built by printing, a heating current generation circuit used for applying a current between the molten or softened flowable metal and the metal built by printing forfor realizing resistance heating, a metal raw material delivery unit, and a control unit with a computer as its core; wherein the heating unit, the position driving mechanism, the heating current generation circuit and the metal raw material delivery unit are respectively connected to the control unit and are controlled by the control unit; the control unit receives files, parameters and control commands required by three-dimensional printing and input by the user; and the metal raw material delivery unit delivers the metal raw material required by three-dimensional printing into the heating unit;

the metal built by printing is referred to as metal B; and the molten or softened flowable metal generated from the heating unit is referred to as metal A.

In a preferred embodiment, the heating unit is provided with an outlet, after being heated in the heating unit, the metal raw material is output via the outlet of the heating unit to form metal A; and the number of the heating unit or heating units is at least one.

In a preferred embodiment, there are a plurality of heating units, the outlet size of each heating unit can be different. For example, the number of the heating units is two, the two heating units share a part of the structure, but are separately and independently controlled; the inner diameter of the outlet of one heating unit is 50 micrometers, while the inner diameter of the outlet of the other heating unit is 1 mm, the heating unit with the inner diameter of the outlet being 1 mm is used for coarse printing, while the heating unit with the inner diameter of the outlet being 50 micrometers is used for fine printing; and the two heating units work cooperatively in the printing process to realize high speed printing.

In a preferred embodiment, the heating unit is mainly composed of a heating chamber, an electromagnetic induction coil and a cap nut, wherein the heating chamber is internally provided with a cavity, a lower part of the heating chamber is provided with an outlet, an upper end of the heating chamber is connected to the cap nut; the cap nut is provided with a cooling structure used for cooling or performing heat dissipation on the cap nut; the cap nut is provided with a through hole connected to the metal raw material delivery unit, the metal raw material delivery unit feeds the metal raw material into the heating chamber via the through hole; the electromagnetic induction coil is arranged on the periphery of the heating chamber, the electromagnetic induction coil is connected to the control unit, and through the coupling effect of the electromagnetic induction coil, an induced current is generated in the heating chamber and/or the metal raw material in the heating chamber and heat is generated.

In a preferred embodiment, a stirring unit is further included, the stirring unit is used for stirring the metal raw materials in the heating chamber, and eliminating bubbles mixed in the metal raw material; and the stirring unit adopts a manner of mechanical stirring or magnetic stirring.

In the case of mechanical stirring, a stirring rod is adopted to stir the metal raw material in the heating chamber; in the case of magnetic stirring, by arranging a magnetic field generation apparatus for generating a rotating magnetic field or an oscillating magnetic field on the periphery of the heating chamber, and by electrifying the metal raw material in the heating chamber, the metal raw material in the heating chamber is stirred by utilizing an ampere force.

In a preferred embodiment, the position driving mechanism is a multiaxial movement mechanism, such as an XYZ triaxial movement mechanism or a five-axis mechanical arm.

In a preferred embodiment, the heating current generation circuit is connected to metal A and metal B; the connection state between metal A, metal B and the heating current generation circuit is controlled by the control unit, and/or the working state of the heating current generation circuit is controlled by the control unit.

In a preferred embodiment, the control unit is mainly composed of a computer, a drive circuit and a sensing circuit, wherein the computer is a general-purpose computer, or an embedded computer, or an industrial personal computer, or a hybrid computer system constituted by a general-purpose computer and an embedded computer, or a hybrid computer system constituted by an industrial personal computer and an embedded computer, or a hybrid computer system constituted by a general-purpose computer, an industrial personal computer and an embedded computer; the drive circuit drives implementation mechanisms including the heating unit, the position driving mechanism, the heating circuit generation circuit and the metal raw material delivery unit, and supplies drive currents and/or drive signals to the implementation mechanisms; and the computer acquires the state information required by three-dimensional printing through the sensing circuit.

In a preferred embodiment, the metal raw material delivery unit is mainly composed of a metal raw material bin, a metal raw material delivery drive mechanism and a metal raw material delivery line, wherein the metal raw material delivery line connects the metal raw material bin, the metal raw material delivery drive mechanism and the heating unit together, the metal raw material bin is used for storing metal raw materials, and under the effect of the metal raw material delivery drive mechanism, the metal raw material runs through the metal raw material delivery line and reaches the heating unit. The metal raw material can be in a form of metal powder or metal wire.

In a preferred embodiment, a protective gas delivery unit is further included. The protective gas delivered by the protective gas delivery unit is mainly used for protecting the heated metal and/or promoting (regulating) the flow of metal A; the protective gas delivery unit is controlled by the control unit; the protective gas is originated from other systems (e.g., a high-pressure tank is used as the protective gas source of the apparatus for metal three-dimensional printing, and the high-pressure tank stores inert gases produced by other systems), or the protective gas is produced by the protective gas delivery unit (e.g., oxygen in the air is eliminated by utilizing molecular sieves, and the remaining gas is used as protective gas to be used in the printing of some metals which cannot react with nitrogen).

The above protective gas delivery unit is mainly composed of a protective gas source, a delivery line, an electromagnetic valve and a pressure sensing module; the electromagnetic valve and the pressure sensing module are arranged on the delivery line; the electromagnetic valve controls the quantity of the gas output to the delivery line by the protective gas source and the duration time; the pressure sensing module monitors the gas pressure on two sides of the electromagnetic valve in the delivery line; the delivery line guides the gas provided by the protective gas source to the space in which the process of three-dimensional building by printing is conducted to form a protective atmosphere, and guides the gas to the heating unit to promote the flow of metal A.

In a preferred embodiment, a cooling unit is further included, the cooling unit is used for cooling a position which is influenced by a high temperature but cannot withstand it and/or which does not need to be heated, such as cooling the electromagnetic induction coil, the part of the heating unit, which is connected to other components, the position driving mechanism, or even the casing of the apparatus; and the cooling unit is controlled by the control unit.

In a preferred embodiment, a build cavity is further included, a process of building by printing is performed in the build cavity, and the build cavity isolates the process of building by printing from the air.

In a preferred embodiment, a cool air injection unit is further included, the cool air injection unit is used for rapidly cooling the built metal B, so as to change the property of metal B and obtain an effect of “quenching”; and the cool air injection unit is controlled by a control unit.

In a preferred specific embodiment, an excessive metal A collector for collecting metal A is further included; in the cases such as the heating unit is transferred in a cross-area manner by a long distance, etc. in a preparatory stage before formally beginning to print, in the process of suspending printing and in the process of printing, the excessive metal A collector prevents metal A from gathering and dropping off; and the excessive metal A collector is controlled by the computer.

The above excessive metal A collector adopts a reversible or rotatable structure, and is mainly composed of a collecting plate, a rotating shaft and a rotational drive mechanism (such as a motor or an electromagnet); when the excessive metal A collector is working, the collecting plate of the excessive metal A collector is reversed or rotated to a position below the heating unit, under this state, the space below the heating unit is adjusted to be big enough to accommodate the collecting plate of the excessive metal A collector.

The present invention has the following beneficial effects:

(1) In the present invention, through applying a current in a process of building pixel points and utilizing the principle of resistance heating (this principle is different from some principles including electric arc heating and high-temperature plasma heating used by some existing metal three-dimensional printing technologies), the interface between the built metal body and the pixel point being built currently is melted or the temperature of the interface is increased through the spatial resolution of a single pixel point, and the interlayer binding force of the metal body generated by printing is improved; especially when the current pixel point being built is still in a state of melting (the maintenance time of the melting state is extremely short), one side of the built metal body at the interface is instantly melted by utilizing the current, a miniature “melting pool” close to the interface is generated on one side of the built metal body, so the two can be connected in a “molten” manner, such a connection process is similar to “resistance welding”, equivalent to the fact that each pixel point is precisely welded on the built metal body; therefore, by utilizing the technology in the present invention, the strength of the component generated by printing is high.

(2) In the present invention, through the contact between the molten or softened metal (especially the molten metal) and the built metal body, and through a mechanical acting force existing in the contact process, the gas between the pixel points and between the layer being built and the previously well-built layer is driven away and the gap is filled, and the “gap network” between the pixel points and between the layers are little (the “gap network” structure is commonly seen in the existing selective laser melting (SLM) technology and Electron Beam Melting (EBM) technology utilizing a manner of paving a metal powder layer, and high-temperature heating process needs to be performed after printing to improve material density); therefore, the density of the metal component printed by utilizing the technology in the present invention is high.

(3) In the building process of each single pixel point in the present invention, through monitoring whether the metal raw material of each pixel point is in electrical connection with the built metal body (namely, whether the two are in contact with each other) by utilizing a circuit, to realize the monitoring in real time of the building process of each pixel point, and ensure that each pixel point can be effectively connected to the built metal body.

(4) In the present invention, through controlling the on/off state or the intensity of the current between the pixel points in a specific area and the metal body built by printing, while a metal component with a strong interlayer binding force is printed, a metal body with a weak interlayer binding force is generated synchronously to serve as a support, and the support is removed after the printing process is finished; the present invention can also use a plurality of nozzles (or use a plurality of metal liquefying units), one or some nozzles output metal raw materials with a higher melting point to print the target component, while the other one or some other nozzles output the metal raw material with a lower melting point to print an auxiliary support body, and after the printing process is finished, the metal with a low melting point is molten and eliminated; therefore, in the present invention, an auxiliary support/support body can be generated synchronously to print a complex component, such as a metal component which is internally provided with complex cavities and pipelines.

(5) In the present invention, after the metal raw material is molten or softened after being heated (particularly after being molten), under the effect of an extrusion pressure, the molten or softened metal raw material is output through a miniature nozzle (or outlet) of the heating unit, and a small-diameter pixel point can be generated by utilizing a small-bore nozzle (such as a nozzle with an inner diameter of 50 micrometers); if a “dragging” manner is utilized, namely, while the liquid metal is in contact with the metal body built by printing, the nozzle is quickly moved, as the liquid metal has viscosity itself, a pixel point with an inner diameter being smaller than that of the nozzle can be generated; as the position of the nozzle is accurately controlled, the position of the extruded liquid metal is also precisely controlled (which is different from some existing metal three-dimensional printing technologies utilizing a manner of “spraying metal powder”), and the pixel point and the built metal body are connected through resistance heating, “resistance heating” has a small scope in its energy effect and a high controllability (which is different from some existing metal three-dimensional printing technologies utilizing heating manners of electric arc heating or high-temperature plasma heating), therefore, the building precision of the present invention is high.

(6) In the present invention, a simple movement chive mechanism is adopted to control the position of the miniature metal liquefying unit (namely, the heating unit) and a resistance heating manner is adopted to enhance the interlayer binding force, and the printed format is determined by the movement control range of the movement chive mechanism. If a large-scale multiaxial movement mechanism, such as a large-scale XYZ triaxial movement control mechanism, is adopted, then a large-scale metal structural component can be printed.

(7) In the present invention, a simple movement drive mechanism is adopted, a miniature heating unit is adopted to generate liquid or softened metal, only a miniature heating unit maintains a high temperature state, and a simple metal raw material delivery mode is adopted; therefore, the apparatus can have a simple structure.

(8) In the present invention, building can be realized through pure current heating, with no need of a high-power laser system (as the high-power laser system is expensive and the service life of a laser is commonly within 10 thousand hours), the process of building by printing can also be realized in a non-vacuum environment (building needs to be performed in a vacuum environment when the electron beam machining (EBM) technology is adopted, and the costs of manufacturing and use of the EBM device are high), the implementation cost of the present invention is low, namely, the production cost and use cost are low.

In conclusion, the present invention has the following beneficial effects: the produced metal components have high strength and density and high building precision; the printing process of each pixel point is monitored; a removable auxiliary support can be produced synchronously; a large-scale component can be printed; the apparatus is simple in structure and low in cost; and the metal three-dimensional printing technology can be promoted to be popularized in such fields as industrial production, prototype design and creative design and the like. The present invention possesses a substantial progress.

### BRIEF DESCRIPTION OF THE DRAWINGS

FIG. 1 is a three-dimensional perspective view for illustrating the overall structure of a first preferred specific embodiment of an apparatus for metal three-dimensional printing of the present invention;

FIG. 2 is a schematic diagram for illustrating the composition principle of a first preferred specific embodiment of the apparatus for metal three-dimensional printing of the present invention as shown in FIG. 1;

FIG. 3 is a schematic diagram for illustrating the principle of building by printing of a first preferred specific embodiment of a method for metal three-dimensional printing of the present invention, wherein the arrow D1 represents a movement direction;

FIG. 4 is a schematic diagram for illustrating the principle of building by printing of a first preferred specific embodiment of a method for metal three-dimensional printing of the present invention, wherein the arrow D2 represents a movement direction;

FIG. 5 is a schematic diagram, and is an enlarged view of the part encircled by a dashed circle, for illustrating the building principle of the first preferred specific embodiment of the method for metal three-dimensional printing of the present invention;

FIG. 6 is a schematic diagram for illustrating a case in which bubbles exist inside the molten metal raw material;

FIG. 7 and FIG. 8 are schematic diagrams for illustrating that in the first preferred specific embodiment of the method for metal three-dimensional printing of the present invention, a removable auxiliary support is printed synchronously while a metal component as required is printed.

FIG. 9 and FIG. 10 are flow charts for illustrating the process of building by printing of the first preferred specific embodiment of the method for metal three-dimensional printing of the present invention, wherein reference numerals S101 to S110 in FIG. 9 and reference numerals S201 to S210 in FIG. 10 are used for indicating specific steps of the flow;

FIG. 11 and FIG. 12 are schematic diagrams for illustrating the principle of printing a component which is internally provided with a channel of a second preferred specific embodiment of the method for metal three-dimensional printing of the present invention;

FIG. 13 is a schematic diagram for illustrating the overall structure of a third preferred specific embodiment of the apparatus for metal three-dimensional printing of the present invention;

FIG. 14 is a schematic diagram for illustrating the principle of a fourth preferred specific embodiment of the apparatus for metal three-dimensional printing of the present invention, wherein arrow D3 represents a movement direction, and arrow F1 represents an air flow;

Reference numerals in the figures: 1—metal liquefying unit used for generating molten flowable metal, 2—XY guide (rail) system, 3—printing support platform, 4—build cavity, 5—metal raw material delivery line, 6—protective gas source, 7—shell, 8—heating current generation circuit, 9—conduction (continuity) detection circuit, 10—support layer, 11—metal raw material bin, 12—metal raw material delivery drive mechanism, 13—electromagnetic valve and pressure sensing module I, 14—heating chamber, 15—cap nut, 16—electromagnetic induction coil, 17—insulating layer, 18—nozzle of the heating chamber, 19—cooling module I, 20—electromagnetic induction heating and driving module, 21—cooling module II, 22—electromagnetic valve and pressure sensing module II, 23—molten metal raw material, 24—molten metal flowing out from the heating chamber, 25—metal built by printing II, 26—metal built by printing I, 27—bubble I, 28—bubble II, 29—component I, 30—support I, 31—component III, 32—support body III, 33—cool air nozzle, 37—vacuum pump, 39—heating chamber II, 45—build cavity II, 46—printing support platform II.

### DETAILED DESCRIPTION OF THE EMBODIMENTS

The present invention will be described in detail by giving, as examples, two preferred specific embodiments of the method for metal three-dimensional printing of the present invention and four preferred specific embodiments of the apparatus for metal three-dimensional printing of the present invention in combination with the accompanying drawings, wherein the first and second preferred specific embodiments of the apparatus for metal three-dimensional printing of the present invention respectively employ the first to second preferred specific embodiments of the method for metal three-dimensional printing of the present invention.

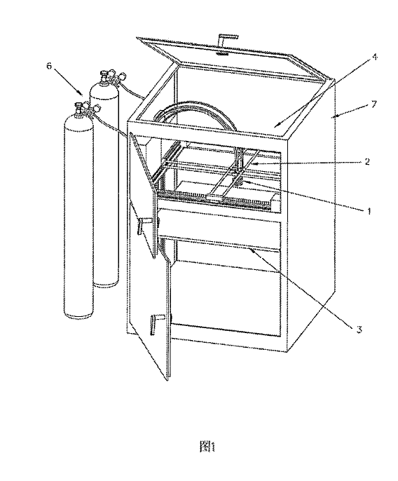

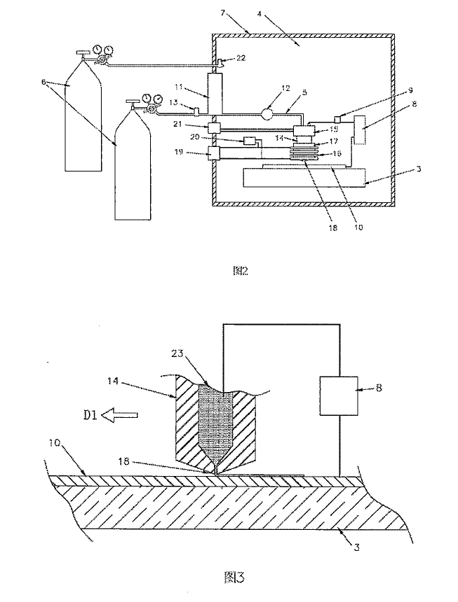

The first preferred specific embodiment of a method for metal three-dimensional printing of the present invention is shown in FIG. 3 to FIG. 10: a method for metal three-dimensional printing comprising (or with) a main process as follows: molten or softened flowable metal is placed in a build area (corresponding to the build cavity 4 as shown in FIG. 1 and FIG. 2) used by a three-dimensional printing apparatus, after having no fluidity, the molten or softened flowable metal is converted into metal built by printing, the molten or softened flowable metal is accumulated on the basis of the metal built by printing, until an object to be printed is built and the accumulated metal built by printing forms the object to be printed, wherein in a process of accumulating the molten or softened flowable metal, the position where the molten or softened flowable metal is placed is determined by the shape and the structure of the object to be printed; the build area used by the three-dimensional printing apparatus refers to the space used by the three-dimensional printing apparatus when an object is printed; the molten or softened flowable metal is referred to as metal A, and the metal built by printing is referred to as metal B;

in a portion of a printing area, in a process of accumulating metal A, a current is applied between (in other words, through) metal A and metal B, by way of resistance heating, the part of metal B, which is in contact with metal A, is molten, so that metal A is connected to metal B through a molten manner; in a portion of a printing area, in a process of accumulating metal A, no current is applied between metal A and metal B;

the portion of a printing area refers to a portion of the space to be occupied by metal A and metal B in a process of printing an object. The portion of a printing area can also be understood as a portion of a mapping space, which is formed (or obtained) when the to-be-printed object is mapped to the build area used by the three-dimensional printing apparatus. The portion of a printing area can also be understood as follows: the space to be occupied by the to-be-printed object is divided out in advance, a virtual object in mapping relationship with the to-be-printed object is formed, the virtual object is gradually converted into a real object which is finally built by printing, and the process in which the virtual object is converted into a real object is just a process of three-dimensional printing; and the virtual object is divided into a plurality of areas, and a portion of the area therein is just the so-called a portion of a printing area.

In the present specific embodiment, the object to be printed includes a target component and an auxiliary support, which will be described in detail below.

In the present specific embodiment, the position where metal A is in contact with metal B is controlled by a computer; the current applied between metal A and metal B is controlled by the computer; the object to be printed is generated by superimposing the layers, namely, the object to be printed is generated through the superposition of the object layer by layer, and there are a plurality of layers; each layer is composed of pixel points which are connected to each other; each layer is composed of a single layer of pixel points, the thickness of the layer is the height of the pixel points; metal A is flowable, and whether metal A flows or not is controlled by the computer. In the printing process, metal A exists in a form of metal flow; after the front part of the metal flow is in contact with and connected to metal B, the temperature of the front part of the metal flow is lowered, and the front part of the metal flow is converted into metal B automatically to form pixel points; and the number of the metal flow or metal flows is at least one. The lowered temperature of the front part of the metal flow is due to the fact that the heat in the front part of the metal flow is guided away by a medium, for example, the metal B accumulated previously, the printing support platform of the three-dimensional printing apparatus, and gases in the environment will also guide away a part of the heat.

In the present specific embodiment, the contact manner between metal A and metal B is dragging; in the manner of dragging, in the printing process, metal A exists in a form of liquid entity metal flow (not powdery loose metal flow), in the area to be printed, the metal flow moves relative to metal B and at the same time remains to be in contact with metal B, after being in contact with and connected to metal B, the front part of the metal flow is automatically convened into metal B, and then pixel points are formed, the subsequent metal flow is in contact with a position corresponding to a pixel point to be printed and is continuously converted into metal B, until the printing process is finished or suspended. By way of dragging, high-speed printing can be realized, and the apparatus system has lower control difficulty and longer service life.

Metal B is supported by the support layer 10, namely, in the printing process, the metal built by printing is fixed by the support layer 10, and the support layer 10 serves as the basis for printing the first layer; the support layer 10 is a metal plate fixed on the printing support platform 3, the metal plate and the metal raw material used for printing are of the same material, and a metal plate which is of a different material but can be welded with the target component can also be used; the molten metal 24 flowing out from the heating chamber as shown in FIG. 5 belongs to metal A, and both of the metal built by printing II 25 and the metal built by printing I 26 as shown in FIG. 5 belong to metal B.

In the present specific embodiment, before three-dimensional building, preparatory work needs to be done firstly, for example, the preparatory work comprises: fixing a metal plate on the printing support platform 3 to serve as the support layer 10, importing three-dimensional graphic files in a form of STL, setting the scaling and printing precision of the actual printing components and the three-dimensional graphics, generating a protective atmosphere, and generating molten metal raw material 23 at a preset temperature.

After the preparatory work is finished, three-dimensional building steps from the first layer to the last layer are as follows:

Step S1, beginning to print the first layer, under the control of the computer, metal A is in contact with a position on the support layer 10, corresponding to the first pixel point in a to-be-printed pixel queue generated by the computer of the first layer; and the upper surface of the support layer 10 is coplanar with the bottom surface of the first layer; in the present specific embodiment, in the case that the distance between the outlet of a device for generating metal A and the support layer 10 and the outflow speed of metal A are ensured to be controllable, whether metal A is in contact with the support layer 10 is judged by monitoring whether metal A is in electrical connection with the support layer 10 and the resistance value, namely, metal A and the support layer 10 are both linked up to (introduced into) a detection circuit (corresponding to the conduction detection circuit 9 in FIG. 2), one electrode of the detection circuit is connected to metal A, while the other electrode is connected to the support layer 10, if metal A and the support layer 10 are in contact with each other, the detection circuit forms a loop; meanwhile, the resistance value between metal A and the support layer 10 is also monitored.

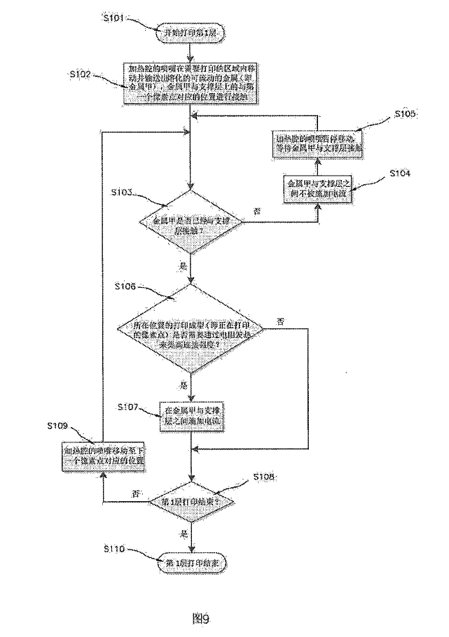

Step S2, applying or not applying a current between metal A and the support layer 10 based on parameters set by the user and generated by computing with the aid of the computer; if a current is required to be applied between metal A and the support layer 10, the intensity of the current is controlled by the computer; in the present specific embodiment, no current needs to be applied when the auxiliary support (such as the support I 30 as shown in FIG. 8) is generated by printing; when the target component (such as the component I 29 as shown in FIG. 7 and FIG. 8) is generated through printing, if the pixel point being printed serves as a strengthened connecting point between the component and the support layer 10, then a current needs to be applied, and the current is of an intensity that is sufficient to melt the contact surface between the support layer 10 and metal A in the set generation time of a single pixel point (e.g., 1/50000 second), while no current needs to be applied for the building of other pixel points. The intensity of the applied current is an empirical value which can be obtained after a plurality of tests. In the present specific embodiment, the support (such as the support I 30 as shown in FIG. 8) is removed after the printing process is finished, and no high binding strength is required between layers of the support.

Step S3, judging whether the printing of the first layer has been completed or not with the aid of the computer, if the printing of the first layer has not been completed, the position where metal A is in contact with the support layer 10 is set to be the position corresponding to the next pixel point, metal A is in contact with the support layer 10, then step S2 and step S3 are repeated; if the printing of the first layer has been completed, and a next layer needs to be printed, then the printing process proceeds to step S4; if a next layer does not need to be printed, the printing process is finished; in the present specific embodiment, if a component (such as the component I 29 as shown in FIG. 7 and FIG. 8) is to be printed, a plurality of layers need to be printed, and each layer is composed of a plurality of pixel points.

step S4, beginning to print a new layer, under the control of the computer, metal A is in contact with a position on the layer previously built by printing, corresponding to the first pixel point in a to-be-printed pixel queue generated by the computer of the current layer; and the upper surface of the layer previously built by printing is coplanar with the bottom surface of the current layer being printed; in the present specific embodiment, metal B is linked up to (or introduced into) a detection circuit (corresponding to the conduction detection circuit 9 in FIG. 2) through the support layer 10, namely, whether metal A is in contact with the layer previously built by printing is monitored through the detection circuit.

step S5, applying or not applying a current between metal A and metal B based on parameters set by the user and generated by computing with the aid of the computer; if a current is applied, the intensity of the current is controlled by the computer; in the present specific embodiment, no current needs to be applied when the support (such as the support I 30 as shown in FIG. 8) is generated by printing; while a current needs to be applied when the component (such as the part I 29 as shown in FIG. 7 and FIG. 8) is generated by printing, and the current is of an intensity that is sufficient to melt the contact surface between metal B and metal A in the set generation time of a single pixel point (e.g., 1/50000 second). The intensity of the applied current is an empirical value which can be obtained after a plurality of tests.

step S6, judging whether the printing of the current layer has been completed or not with the aid of the computer, if the printing of the current layer has not been completed, the position where metal A is in contact with metal B is set to be the position corresponding to the next pixel point, metal A is in contact with metal B, then repeat step S5 to step S6; if the printing of the current layer has been completed and a next layer needs to be printed, then the printing process proceeds to step S7; if a next layer does not need to be printed, the printing process is finished; and

step S7, repeating step S4 to step S6 until the printing process is finished.

In the present specific embodiment, in step S2 and step S5 in the three-dimensional building steps from the first layer to the last layer, the parameters generated by computing is generated by the computer in the following two cases: case 1, based on the shape and the structure of a target component (the component to be printed), a removable auxiliary printed body (e.g., an auxiliary support generated synchronously with the target component) is automatically generated with the aid of the computer. For the convenience of removing, for the building process of most pixel points of the removable auxiliary printed body, no resistance heating is required for enhancing the structural strength thereof, and all the pixel points, which do not need resistance heating to enhance the structural strength thereof, of the removable auxiliary printed body are all labeled with the parameters indicating that no current needs to be applied; case 2, for the building process of all the pixel points in the entity area of the target component, resistance heating is required to enhance the structural strength thereof, and all the pixel points in the entity area of the target component are labeled with the parameters indicating that the current needs to be applied.

In the present specific embodiment, the portion of a printing area is mainly determined by the shape of the component to be printed and the algorithm optimized by the computer. When the first layer is printed, in order to conveniently fix the component to be printed on the support layer 10, but in order to conveniently remove the component printed from the support layer 10, the current is only applied to the position where four equal division points on the contour line of the first layer of the component to be printed are in contact with the support layer 10 and the position where the contour central point of the first layer is in contact with the support layer 10 to enhance the connections at these positions, while in other areas of the first layer, no current needs to be applied between metal A and the support layer 10, so as to prevent a too strong binding force between the component to be printed and the support layer 10, the too strong binding force will make it difficult to remove the component printed from the support layer.

In the present specific embodiment, the portion of a printing area can also be divided into an area with a high building strength and an area with a low building strength. For example, all the layers of the target component is set to be an area with a high building strength, and the area with a high building strength is connected and built in a molten manner; and all the layers of auxiliary structures such as the support body are set to be an area with a low building strength, and no current needs to be applied in the building process of the area with a low building strength. For the auxiliary support/support body (such as the support I 30 as shown in FIG. 8), the support is removable after the printing process is finished.

In the present specific embodiment, the molten degree of metal A is adjustable, which is realized through adjusting the temperature level of metal A, and is controlled by the computer; the computer obtains the temperature of the heating chamber 14 and the temperature of the protective atmosphere environment in which the heating chamber 14 is located through a sensor, so as to estimate the temperature of the molten metal raw material 23, a superhigh-temperature thermocouple can also be arranged in the internal cavity of the heating chamber 14 to detect the temperature of the metal raw material 23; the level of the temperature of metal A can be controlled by adjusting the temperature of the molten metal raw material 23 and controlling the blown-out velocity of metal A. These parameters are empirical values which can be obtained through a plurality of tests; these empirical values are stored as a data table, and in the printing process, based on the printing mode set by the user, the computer calls (or uses) corresponding empirical values to serve as control parameters. The flow speed and the flow rate in unit time of metal A are adjustable, which can be realized through adjusting the level of extrusion pressure exerted on metal A and controlled by the computer; when the inner diameter of the nozzle 18 of the heating chamber is a fixed value, the temperature and the extrusion force of the molten metal raw material 23 determine the flow velocity and the flow rate in unit time of metal A, these are also empirical values obtained after a plurality of tests, and an empirical value data table is formed, and in the printing process, based on the printing mode set by the user, the computer calls corresponding empirical values to serve as control parameters.

In the present specific embodiment, before metal A is in contact with metal B, the region of metal B, which is to be in contact with metal A, is preheated through a manner of electromagnetic induction heating; an electromagnetic induction coil 16 is arranged on the periphery of the heating chamber 14, the lowest end of the electromagnetic induction coil 16 is flush with the lowest end of the nozzle 18 of the heating chamber, and during the movement of the heating chamber 14, the lowest end of the electromagnetic induction coil 16 is ensured to be not in contact with the metal built by printing (namely, metal B); while the electromagnetic induction coil 16 heats the metal raw material, a magnetic line of force at the lower end of the electromagnetic induction coil 16 will cause the metal B just below the electromagnetic induction coil 16 to induce an eddy current to generate heat, however, since the magnetic line of force at the lower end of the electromagnetic induction coil 16 is weaker than that of the central segment of the spiral center of the electromagnetic induction coil 16, and the size of metal B is larger (relative to metal A), the heat of metal B is guided away (e.g., the protective atmosphere, the support layer 10 and the printing support platform 3 will also guide away the heat of metal B), and the heating time of metal B is short as the electromagnetic induction coil 16 always moves along with (or following) the heating chamber 14, therefore, the electromagnetic induction coil 16 can only preheat metal B, and a temperature high enough to melt metal B cannot be reached. When a current is applied between metal A and metal B, the power supply of the electromagnetic induction coil 16 is cut off, so as to prevent metal A from being pushed or disturbed by an ampere force, but the direction of the current applied between metal A and metal B is in parallel to the magnetic line of force inside the electromagnetic induction coil 16, and the generated ampere force is negligible in normal conditions.

In the present specific embodiment, a current is applied between metal A and metal B only after it is monitored that metal A and metal B are in contact with each other, namely, the heating current generation circuit 8 outputs voltage only after metal A and metal B are in contact with each other; if before metal is in contact with metal B, the heating current generation circuit 8 is in a state of outputting voltage, then an electric spark may be generated at the instant when metal A is in contact with metal B.

Specific application solutions:

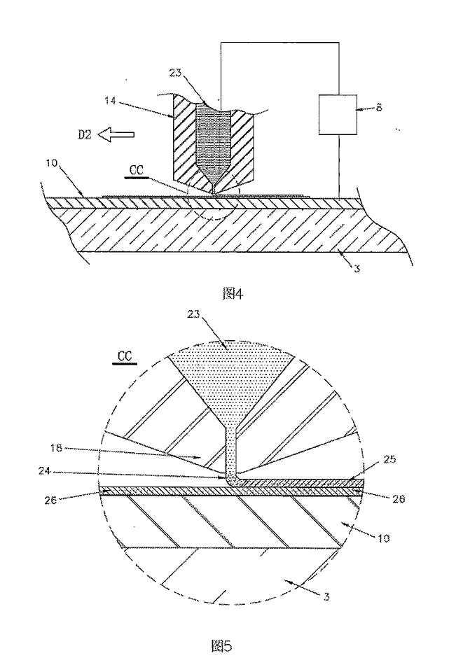

As shown in FIG. 3 to FIG. 5, the arrows D1 and D2 in the figures represent movement directions of the heating chamber 14. The molten metal raw material 23 in the heating chamber 14 is obtained by causing the temperature of the metal raw material to be higher than the melting point of the metal raw material through high-frequency electromagnetic induction heating. The lower end of the heating chamber 14 is a nozzle 18 of the heating chamber, the nozzle 18 of the heating chamber is fortned with a through hole with an inner diameter of 50 micrometers. As shown in FIG. 3, the first layer is being printed, under the effect of an extrusion pressure, the molten metal 24 (belonging to metal A) flowing out from the heating chamber is in contact with the support layer 10, and the contact position corresponds to the position of the pixel point being printed. As shown in FIG. 4 and FIG. 5, the second layer is being printed. Through controlling the position of the heating chamber 14, the position of the molten metal 24 (namely metal A) flowing out from the heating chamber is controlled. The output electrodes of the heating current generation circuit 8 are respectively connected to the molten metal raw material 23 and the support layer 10.

Component I 29 shown in FIG. 7 and FIG. 8 is an irregular profiled (special-shaped) component (sectional view), the component I 29 is a target component, and the printing of the component needs an auxiliary effect of a support, the support I 30 as shown in FIG. 8 serves as an auxiliary support. The support I 30 is automatically generated with the aid of the computer and can be set as follows: when the included angle between a tangent line to a certain curved surface of a target component (namely, the to-be-printed component with the auxiliary support being removed) and a horizontal plane (in the present specific embodiment, the upper surface of the support layer 10 is the horizontal plane) is smaller than a preset angle, an auxiliary support is generated at the vertical direction below the curved surface at this position, and this auxiliary printing manner employing an auxiliary support is commonly seen in the existing FDM (Fused Deposition Modeling) technology.

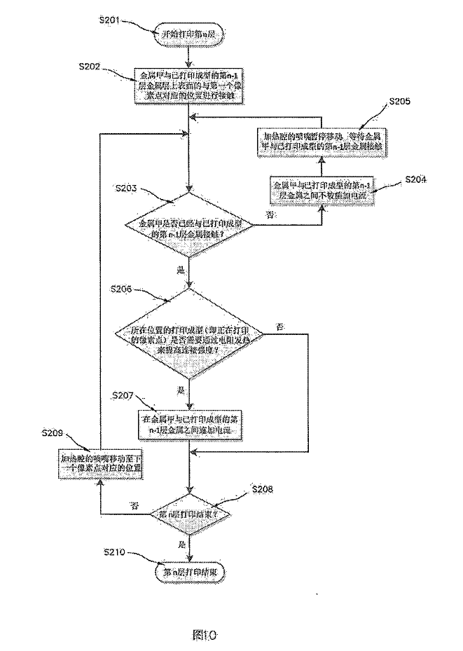

FIG. 9 shows the flow for printing the first layer:

Step S101, after the preparatory work is finished, prepare and begin to print the first layer of a metal object (including the component I 29 and the support I 30); the support layer 10 serves as the basis for printing the first layer; and the distance between the nozzle 18 of the heating chamber and the support layer 10 is adjusted with the aid of a computer, to satisfy the requirement for printing the first layer; wherein the distance value is an empirical value which is obtained after a plurality of tests and which will be described below.

Step S102, metal A is under the control of a computer, the nozzle 18 of the heating chamber moves and delivers molten flowable metal (namely, metal A, as shown in FIG. 3) in an area required to be printed, and metal A is in contact with a position on the upper surface of the support layer 10, corresponding to the first pixel point in a to-be-printed pixel queue generated by the computer of the first layer. The above area required to be printed includes a first layer of the component I 29 and a first layer of the support I 30; the to-be-printed pixel queue generated by the computer of the first layer includes all the pixel points of the first layer of the component I 29 and the first layer of the support I 30, and all the pixel points are sorted under the principle of least time required for printing the whole layer of metal (under this principle, the total length of the path that the nozzle 18 of the heating chamber moves is the shortest).

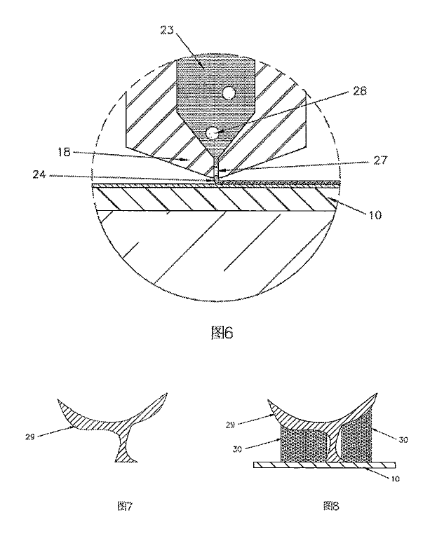

Step S103, the computer judges whether metal A is in contact with the support layer 10, if the answer is “Yes”, then the printing process proceeds to step S106; if the answer is “No”, then the printing process proceeds to step S104. In this step, if metal A is not continuous (e.g., metal A is blocked by bubbles in the generation process, as shown in FIG. 6), it will be monitored.

Step S104, no current is applied between metal A and the support layer 10, namely, the heating current generation circuit 8 does not output a voltage.

Step S105, the nozzle 18 of the heating chamber suspends its movement and waits for a contact between metal A and the support layer 10, and then the printing process proceeds to step S103.

Step S106, the computer judges whether resistance heating is needed for the building by printing of the current position (namely, the pixel point being printed) to improve the connection intensity thereof, if the connection intensity needs to be improved, then the printing process proceeds to step S107; if the connection intensity does not need to be improved, then the printing process proceeds to step S108. In the present specific embodiment, no resistance heating is required for all the pixel points of the first layer of the support I 30 to improve the connection strength; a current is applied to the position where four equal division points on a contour line of the first layer of the component I 29 are in contact with the support layer 10 and the position where the contour central point of the first layer is in contact with the support layer 10 to enhance the connections at these positions, while in other areas of the first layer, no current needs to be applied between metal A and the support layer 10, so as to prevent a too strong binding force between the component to be printed and the support layer, the too strong binding force will make it difficult to remove the component printed from the support layer .

Step S107, the computer controls the heating current generation circuit 8 to output a voltage, a strong current is generated between metal A and the support layer 10, within a time period of 1/50000 second, a miniature melting pool is generated on the side of the support layer 10 at the interface between the current position of metal A (namely, the pixel point being printed) and the support layer 10 (metal A still exists in a molten state at this time), and then the computer controls the heating current generation circuit 8 to stop outputting voltage. The intensity of the applied current is an empirical value which can be obtained after a plurality of tests. Metal A has an extremely small volume, an extremely small thermal capacity and an extremely short maintenance time of the molten state, since such medias as the support layer 10 and the protective atmosphere will guide away the heat of metal A within an extremely short time.

Step S108, the computer judges whether the printing of the first layer is finished, if the answer is “No”, then the printing process proceeds to step S109; if the answer is “Yes”, then the printing process proceeds to step S110.

Step S109, the nozzle 18 of the heating chamber moves to a position corresponding to the next pixel point (the movement of the nozzle 18 of the heating chamber takes the support layer 10 as a reference), and then return to step S103.

Step S110, the printing of the first layer is finished.

FIG. 10 shows the flow for printing the second layer and the subsequent layers (wherein, n represents a number equal to or greater than 2):

Step S201, prepare and begin to print the n^{th} layer of the metal object (including the component I 29 and the support I 30); the computer adjusts the distance between the nozzle 18 of the heating chamber and the n−1^{th} layer previously built by printing to satisfy the requirement for printing the n^{th} layer; the distance value is an empirical value which can be obtained after a plurality of tests and which will be described below.

Step S202, metal A is under the control of a computer, the nozzle 18 of the heating chamber moves and delivers molten flowable metal (namely, metal A, such as the molten metal 24 flowing out from the heating chamber as shown in FIG. 5) in an area required to be printed, and metal A is in contact with a position on the n−1^{th} layer, corresponding to the first pixel point in a to-be-printed pixel queue generated by the computer of the n^{th} layer. The above area required to be printed includes the n^{th} layer of the component I 29 and the n^{th} layer of the support I 30; the to-be-printed pixel queue generated by the computer of the n^{th} layer includes all the pixel points of the n^{th} layer of the component I 29 and the n^{th} layer of the support I 30, and all the pixel points are sorted under the principle of least time required for printing the whole layer of metal (under this principle, the total length of the path that the nozzle 18 of the heating chamber moves is the shortest).

Step S203, a computer judges whether metal A is in contact with the n−1^{th} layer, if the answer is “No”, then the printing process proceeds to step S206; if the answer is “No”, then the printing process proceeds to step S204. In this step, if metal A is not continuous (e.g., metal A is blocked by bubbles in the generation process, as shown in FIG. 6), it will be monitored.

Step S204, no current is applied between metal A and metal B (such as the metal built by printing II 25 and the metal built by printing I 26 as shown in FIG. 5), namely, the heating current generation circuit 8 does not output a voltage. In this step, the metal B which includes the n−1^{th} layer of metal built by printing is actually linked up to the heating current generation circuit 8 through the support layer 10, it can also be understood that no current is applied between metal A and the support layer 10, or no current is applied between metal A and the n−1^{th} layer of metal built by printing.

Step S205, the nozzle 18 of the heating chamber suspends its movement and waits for a contact between metal A and the n−1^{th} layer of metal (belonging to metal B), and then the printing process proceeds to step S203.

Step S206, the computer judges whether resistance heating is needed for the building by printing of the current position (namely, the pixel point being printed) to improve the connection intensity, if the connection intensity needs to be improved, then the printing process proceeds to step S207; if the connection intensity does not need to be improved, then the printing process proceeds to step S208. No resistance heating is required for all the pixel points of the n^{th} layer of the support I 30 to improve the connection strength; and resistance heating is required for all the pixel points of the n^{th} layer of the component I 29 to improve the connection strength.

Step S207, the computer controls the heating current generation circuit 8 to output a voltage, a strong current is generated between metal A and metal B, within a time period of 1/50000 second, a miniature melting pool is generated on the side of metal B at the interface between the current position of metal A (namely, the pixel point being printed) and metal B (metal A still exists in a molten state at this time), and then the computer controls the heating current generation circuit 8 to stop outputting voltage. The intensity of the applied current is an empirical value which can be obtained after a plurality of tests. In this step, the metal B which includes the n−1^{th} layer of metal built by printing is actually linked up to the heating current generation circuit 8 through the support layer 10, it can also be understood that a current is applied between metal A and the support layer 10, or a current is applied between metal A and the n−1^{th} layer of metal built by printing. Metal A has an extremely small volume, an extremely small thermal capacity and an extremely short maintenance time of the molten state, since such media as the metal built by printing (namely metal B) and the protective atmosphere will guide away the heat of metal A within an extremely short time, the heat carried by metal A cannot melt one side of metal B at the contact surface of metal A and metal B; if the side of metal B on the interface between metal A and metal B are melted through resistance heating, the connection strength of metal A and metal B is not high.

Step S208, the computer judges whether the printing of the n^{th} layer has been finished, if the answer is “No”, then the printing process proceeds to step S209; if the answer is “Yes”, then the printing process proceeds to step S210.

Step S209, the nozzle 18 of the heating chamber moves to a position corresponding to the next pixel point, and then return to step S203.

Step S210, the printing of the n^{th} layer is finished.

Since in the melting process of metal raw material, gases may be mixed in the metal raw material, and the present specific embodiment is implemented in a non-vacuum environment, then bubbles, such as the bubbles as shown in FIG. 6 (namely, bubbles I 27 and bubbles II 28), may exist in the molten metal raw material 23. Under the effect of an extrusion force, bubbles may flow out from the nozzle 18 of the heating chamber together with the molten metal raw material 23, which may lead to the fact that the molten metal 24 (namely, metal A) flowing out from the heating chamber may be incoherent. Therefore, a circuit for monitoring whether metal A is in contact with metal B in real time, namely, a conduction detection circuit 9 (belonging to a part of the control unit), is required. Through monitoring in real time whether metal A is in contact with metal B, whether the pixel points being printed currently are valid (namely, whether metal A fills in the position where the pixel point is located) can be judged. Meanwhile, only after it is monitored that metal A has been in contact with metal B, a current is applied to metal A and metal B, which can prevent the generation of electric sparks between metal A and metal B, and further prevent metal A from being pushed away or even blown off by a mini-explosion generated by electric sparks. In the present specific embodiment, the response speed of the conduction detection circuit 9 is extremely high, the sampling frequency is 100 MHz, and the conduction detection circuit 9 can response within a time period of 1/50 million second.

The first preferred specific embodiment of an apparatus for metal three-dimensional printing of the present invention is shown in FIG. 1 and FIG. 2. The preferred specific embodiment is an apparatus of the first preferred specific embodiment employing the above method for metal three-dimensional printing. The preferred specific embodiment includes a heating unit used for generating molten metal (corresponding to the metal liquefying unit 1 used for generating molten flowable metal in FIG. 1), a position driving mechanism used for controlling the contact position between the molten metal and the metal built by printing (corresponding to the XY guide system 2 and the printing support platform 3 in FIG. 1), a heating current generation circuit 8 used for applying a current between the molten metal and the metal built by printing to realize resistance heating, a control unit with a computer as its core (not completely shown in the figure), a metal raw material delivery unit (corresponding to the metal raw material bin 11, the metal raw material delivery drive mechanism 12 and the metal raw material delivery line 5 in FIG. 2), a protective gas delivery unit (including a protective gas source 6, a magnetic valve and pressure sensing module I 13, a magnetic valve and pressure sensing module II 22 and corresponding pipelines), a cooling unit (including a cooling module I 19 and a cooling module II 21) and a build cavity 4; wherein the heating unit, the position driving mechanism, the heating current generation circuit 8, the metal raw material delivery unit, the protective gas delivery unit and the cooling unit are respectively connected to the control unit and are controlled by the control unit; the control unit receives files, parameters and control commands required for three-dimensional printing and input by the user; the heating unit, the position driving mechanism, the heating current generation circuit 8, the metal raw material delivery unit, the protective gas delivery unit and the cooling unit are respectively or partially arranged in the space inside the shell 7; the space inside the shell 7 serves as the build cavity 4 and is filled with a protective gas, and a protective atmosphere is formed in the build cavity 4.

The metal built by printing is referred to as metal B; the molten metal flowing out from the heating unit is referred to as metal A (corresponding to the molten metal 24 flowing out from the heating chamber as shown in FIG. 5).

In the present specific embodiment, the heating unit (corresponding to the metal liquefying unit 1 used for producing molten flowable metal in FIG. 1) is mainly composed of a heating chamber 14, an electromagnetic induction coil 16 and a cap nut 15, wherein the heating chamber 14 is internally provided with a cavity, a nozzle 18 of the heating chamber and an outlet are arranged on the lower end of the heating chamber 14, the upper end of the heating chamber 14 is connected to the cap nut 15, the cap nut 15 and the electromagnetic induction coil 16 are both connected to an XY guide system 2, the cap nut 15 is internally provided with a cooling passage to serve as a cooling structure, the cooling passage is connected to the external cooling module II 21, and the temperature at the connection point between the cap nut 15 and the XY guide system 2 is controlled to be about 50° C.: a through hole connected to the metal raw material delivery line 5 of the metal raw material delivery unit is formed on the cap nut 15, and the metal raw material delivery unit delivers (or feeds) the metal raw material into the heating chamber 14 via the through hole; the electromagnetic induction coil 16 is made of a metal tube, the passage inside the metal tube is connected to the external cooling module I 19, the electromagnetic induction coil 16 is connected to the electromagnetic induction heating and driving module 20 (the electromagnetic induction heating and driving module 20 belongs to a part of the control unit); through the coupling effect of the electromagnetic induction coil 16, an induced current is generated in the heating chamber 14 and the metal raw material in the heating chamber 14 and heat is generated, molten metal raw material 23 is generated in the heating chamber 14; the molten metal raw material 23 flows out from the nozzle 18 of the heating chamber to generate (or form) metal A (corresponding to the molten metal 24 flowing out from the heating chamber in FIG. 5); a lower segment of the heating chamber 14 is wrapped by an insulating layer 17, and the insulating layer 17 is arranged between the heating chamber 14 and the electromagnetic induction coil 16 but does not contact with the electromagnetic induction coil 16. The number of the heating unit is one.

In the present specific embodiment, the cooling unit (including the cooling module 119 and the cooling module II 21) adopts a water cooling mode to cool a position which is influenced by high temperature but cannot withstand it and the position which does not need to be heated, such as cooling the electromagnetic induction coil 16 and the cap nut 15 on the upper end of the heating chamber 14.

In the present specific embodiment, the position driving mechanism is a multiaxial movement mechanism, and adopts a XYZ triaxial movement mechanism; the X axis and the Y axis drive the movement of the heating unit (corresponding to the metal liquefying unit 1 used for generating molten flowable metal), while the Z axis drives the rise and fall (the movement in the vertical direction) of the printing support platform 3.

In the present specific embodiment, the control unit is mainly composed of a computer, a drive circuit and a sensing circuit, wherein the computer is a hybrid computer system constituted by a general-purpose system and an embedded computer, the general-purpose computer is used as a host (upper) computer while the embedded computer (such as MCU taking ARM11 as its core) is used as a slave (lower) computer; the drive circuit drives implementation mechanisms including the heating unit, the position driving mechanism, the heating circuit generation circuit 8, the metal raw material delivery unit, the protective gas delivery unit and the cooling unit, and supplies drive currents and/or drive signals to the implementation mechanisms; and the computer acquires various state information required for three-dimensional printing through the sensing circuit, such as the information including position, pressure intensity, temperature, current intensity, gas component, rotating speed, magnetic field intensity, capacitance, resistance, humidity, infrared rays, images and the like. The electromagnetic induction heating and driving module 20 and the conduction detection circuit 9 in FIG. 2 both belong to a part of the control unit.

In the present specific embodiment, the heating current generation circuit 8 is connected to metal A through the molten metal raw material 23 and connected to metal B through the support layer 10; the working state of the heating current generation circuit 8 is controlled by the control unit.

In the present specific embodiment, the metal raw material is in a form of metal wire/metal thread; the metal raw material delivery unit is mainly composed of a metal raw material bin 11, a metal raw material delivery drive mechanism 12 and a metal raw material delivery line 5, wherein the metal raw material delivery line 5 connects the metal raw material bin 11, the metal raw material delivery drive mechanism 12 and the cap nut 15 of the heating unit together; the metal raw material bin 11 stores the metal wire which is wound on a rotatable wire reel inside the metal raw material bin 11; the metal raw material delivery drive mechanism 12 adopts a wire-feeding-roller structure, under the pulling/pushing of the metal raw material delivery drive mechanism 12, the metal wire runs in the metal raw material delivery line 5 and reaches the inside of the heating chamber 14 of the heating unit.

In the present specific embodiment, the protective gas delivered by the protective gas delivery unit is argon, which is used for protecting the heated metal, such as preventing the molten metal raw material 23, the molten metal 24 flowing out from the heating chamber, and the heated, built metal from reacting with the components in the air; the protective gas is originated from a gas cylinder (corresponding to the protective gas source 6 in the drawing); the protective gas delivery unit is mainly composed of a protective gas source 6, a delivery line, an electromagnetic valve, a pressure sensing module I 13, an electromagnetic valve, and a pressure sensing module II 22; based on the set pressure intensity, gas concentration and other parameters, the control unit compares the actual data obtained from such sensors including a pressure sensor and a gas sensor (e.g., an oxygen concentration sensor), controls the on-off state and the frequency of the on-off of the electromagnetic valve to realize the adjustment of the pressure intensity and the concentration of the protective gas inside the build cavity 4, and realize the adjustment of the pressure intensity inside the heating chamber 14; the electromagnetic valve adopted in the present specific embodiment is a high-speed electromagnetic valve.

In the present specific embodiment, through the adjustment of the pressure intensity of the argon inside the heating chamber 14, the adjustment of the extrusion pressure exerted on the molten metal raw material 23 can be realized. When a gas is utilized to promote the outflow of the molten metal raw material 23 to form metal A (corresponding to the molten metal 24 flowing out from the heating chamber in FIG. 5), high-temperature isolation is easily realized and the embodiment is feasible.

In the present specific embodiment, the heating chamber 14 is made of high-temperature resistant material, such as special tungsten alloy; the cap nut 15 connected to the upper end of the heating chamber 14 is made of nickel-based high-temperature alloy; the insulating layer 17 is made of zirconium ceramic; and the metal raw material is nickel-titanium alloy. The metal raw material inside the heating chamber 14 is heated to about 2000° C., and under the pushing of the extrusion pressure greater than 1 atmospheric pressure, metal A (corresponding to the molten metal 24 flowing out from the heating chamber as shown in FIG. 5) is generated.

In the present specific embodiment, as shown in FIG. 3, when the first layer is printed, the distance between the lower end of the nozzle 18 of the heating chamber and the support layer 10 is 1.5 to 2 times as great as the inner diameter of the nozzle 18 of the heating chamber (namely, 75-100 μm); as shown in FIG. 4 and FIG. 5, when other layers are printed, the distance between the lower end of the nozzle 18 of the heating chamber and the previous layer built by printing is 1.5 to 2 times as great as the inner diameter of the nozzle 18 of the heating chamber; under the extrusion pressure of 2 standard atmospheric pressure, when the temperature of the nickel-titanium alloy liquid is about 2000° C. or the temperature of the 316 stainless liquid is about 1800° C., and when the movement speed of the nozzle 18 of the heating chamber is 1 m/second, the liquid metal can be ensured to be in normal contact with the support layer 10 or the previous metal layer built by printing, and the width of the built pixel band (a single one) is basically maintained to be the dimension of the inner diameter of the nozzle 18 of the heating chamber.

In the above process of building by printing, when the second layer and the subsequent other metal layers are printed, metal A has an extremely small volume, an extremely small thermal capacity and an extremely short maintenance time of the molten state, since such media as the metal built by printing (namely metal B) and the protective atmosphere will guide away the heat of metal A within an extremely short time, the heat carried by metal A cannot melt one side of metal B at the contact surface of metal A and metal B; if the side of metal B at the interface between metal A and metal B cannot be melted through resistance heating, the connection strength of metal A and metal B is not high, then under the effect of an external force (e.g., a bending force), one layer is easily separated from another layer, while one pixel point is easily separated from another pixel point; similarly, when the first layer of metal is printed, the same problem is confronted. For most metals, the melting point is greatly different from the boiling point, e.g., under one atmospheric pressure, titanium has a melting point of 1660° C. and a boiling point of 3287° C. (data source: baidu encyclopedia). As the resistance of metal is increased along with the increase of the temperature, while the current tends to flow to the part with a low resistance; the surface of metal A is a curved surface/non-flat surface, metal A is flowable, and also metal A is in relative movement to metal B, in a process of accumulating metal A, the contact between metal A and metal B is a dynamic process, leading to the fact that in the process of forming a single pixel point, the process of the contact between metal A and metal B is a process extending from a smaller pan to all the contact surface of metal A and metal B of the whole pixel point, that is to say, the part where contact occurs firstly is heated by the current and has a rising temperature and rising resistance, while the part where the contact occurs subsequently has a relatively low temperature and low resistance, the current flows to the part where contact occurs subsequently, so the temperature of the part where contact occurs subsequently is rising, and finally the interface of metal A and metal B of the whole pixel point is heated by the current, and the heating process by the current is conducted in an extremely short time (such as shorter than 1/50000 second); if a current with a sufficient intensity (such as 100 amperes) is applied within a short enough time (such as 1/100000 second), then the power density is high enough, the temperature rising speed of the interface of metal A and metal B exceeds the heat diffusion speed thereof, causing the generation of a miniature melting pool at a position close to the interface on the side of metal B of the interface, therefore, metal A and metal B are connected in a molten manner, namely, “metallurgical fusion”.

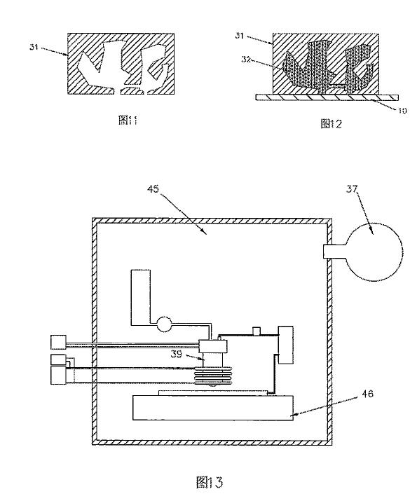

In the second preferred specific embodiment of the method for metal three-dimensional printing of the present invention as shown in FIG. 11 and FIG. 12, the method is as follows: on the basis of the first preferred specific embodiment of the method for metal three-dimensional printing of the present invention in FIG. 3 to FIG. 10, metals with two different melting points are taken as raw materials, the metal raw materials with the two different melting points are utilized to respectively generate two kinds of independently controllable metal A, namely, there are two paths of metal A (which exists in a form of metal flow); the metal A with a higher melting point is used to print and generate a target component (corresponding to component III 31 in the figure), while the metal A with a lower melting point is used to print and generate a support (corresponding to the support body III 32 in the figure); after the printing process is finished, the component III 31 and the support body III 32 are heated to a temperature higher than the melting point of the support III 32 but lower than the melting point of the component III 31, and the support body 32 is removed (moved away).

In the present specific embodiment, a metal component with a complex cavity structure internally can be printed. In the design stage of the component, a pore path for discharging the molten metal with a low inciting point should be reserved. In the printing process, the metal with a low melting point fills the cavity inside the metal component and the surrounding space; after the printing process is finished, the metal with a lower melting point inside the component is discharged.

The second preferred specific embodiment of the apparatus for metal three-dimensional printing of the present invention employs the above second preferred specific embodiment of the method for metal three-dimensional printing of the present invention. In the present preferred specific embodiment, on the basis of the first preferred specific embodiment of the apparatus for metal three-dimensional printing of the present invention as shown in FIG. 1 and FIG. 2, a heating unit for generating metal A is mainly added, so the number of the heating units is two, meanwhile, a position driving mechanism matched with the heating unit and used for controlling the contact position between metal A and metal B, a heating current generation circuit used for applying a current between metal A and metal B to realize resistance heating, a metal raw material delivery unit, a protective gas delivery unit and a cooling unit are also added; and the two heating units are respectively independently controlled by the control unit.

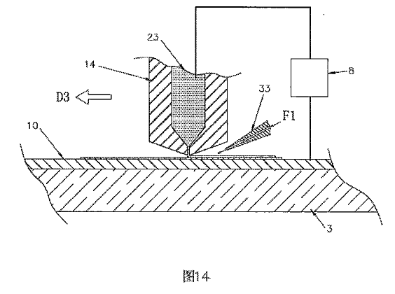

In the third preferred specific embodiment of the apparatus for metal three-dimensional printing of the present invention as shown in FIG. 13, a protective gas delivery unit and an insulating layer of the heating unit are removed on the basis of the first preferred specific embodiment of the apparatus for metal three-dimensional printing of the present invention as shown in FIG. 1 and FIG. 2; the heating unit is fixed, the printing support platform (corresponding to the printing support platform II 46 in FIG. 13) is connected to the XYZ triaxial movement mechanism, the printing support platform can move three-dimensionally; a vacuum pump 37 is added, and a vacuum environment is generated in the build cavity II 45. The diameter of the inner space of the heating chamber (namely heating chamber II 39) of the heating unit in the present specific embodiment is the same as the diameter of the used metal wire (metal raw material), the metal wire is considered as a piston, particularly, the transitional area (belonging to a softened area) of the metal wire between a solid state and a liquid state can play a role of sealing, but can still be pushed, and the liquid metal raw material is pushed out to form metal A by utilizing a pushing force of the metal wire. The present specific embodiment can prevent the protective gas or the relatively active gas mixed in the protective gas from reacting with metal A and the metal raw material in a high temperature state, although such a reaction is negligible in normal conditions, however, in special fields (for example, the manufacturing of implantable medical devices), such a reaction is not negligible.

In the fourth preferred specific embodiment of the apparatus for metal three-dimensional printing of the present invention as shown in FIG. 14, a cool air injection unit is added on the basis of the first preferred specific embodiment of the apparatus for metal three-dimensional printing of the present invention as shown in FIG. 1 and FIG. 2. The cool air injection unit injects a low-temperature protective gas onto the area which has just been built by printing (belonging to metal B), and is used for performing partial quenching on the metal component, so as to control the structural characteristics of the material inside the metal component.

In the present specific embodiment, the cool air injection unit is mainly composed of a refrigerator, a gas pipeline, an electromagnetic valve and a cool air nozzle 33. The cool air nozzle 33 guides and injects the low-temperature protective gas (such as argon with a temperature of −30° C.) into the area which has just been built by printing, such as the airflow injection area shown by arrow F1 as shown in FIG. 14. The arrow D3 in FIG. 14 represents the movement direction of the heating unit.

What is described above are only some preferred specific embodiments of the present invention, which cannot define the implementation range of the present invention, namely, equivalent changes and modifications made based on the contents of the claims and description of the present invention shall all fall into the protection scope of the present invention.

1. A method for metal three-dimensional printing comprising a main process as follows: molten or softened flowable metal is placed in a build area used by a three-dimensional printing apparatus, after having no fluidity, the molten or softened flowable metal is converted into metal built by printing, the molten or softened flowable metal is accumulated on the basis of the metal built by printing, until an object to be printed is built and the accumulated metal built by printing constitutes the object to be printed, wherein in a process of accumulating the molten or softened flowable metal, the position where the molten or softened flowable metal is placed is determined by the shape and the structure of the object to be printed; the build area used by the three-dimensional printing apparatus refers to the space used by the three-dimensional printing apparatus when an object is printed; the molten or softened flowable metal is referred to as metal A, and the metal built by printing is referred to as metal B;
characterized in that
in a process of accumulating metal A, a current is applied between metal A and metal B, by way of resistance heating, the part of metal B, which is in contact with metal A, is molten;
or, in a process of accumulating metal A, a current is applied between metal A and metal B, by way of resistance heating, the part of metal B, which is in contact with metal A, has a raised temperature but is not molten;
or, in a portion of a printing area, in a process of accumulating metal A, a current is applied between metal A and metal B, by way of resistance heating, the part of metal B, which is in contact with metal A, is molten; in a portion of a printing area, in a process of accumulating metal A, a current is applied between metal A and metal B, by way of resistance heating, the part of metal B, which is in contact with metal A, has a raised temperature but is not molten;
or, in a portion of a printing area, in a process of accumulating metal A, a current is applied between metal A and metal B, by way of resistance heating, the part of metal B, which is in contact with metal A, is molten; in a portion of a printing area, in a process of accumulating metal A, a current is applied between metal A and metal B, by way of resistance heating, the part of metal B, which is in contact with metal A, has a raised temperature but is not molten; in a portion of a printing area, in a process of accumulating metal A, no current is applied between metal A and metal B;
or, in a portion of a printing area, in a process of accumulating metal A, a current is applied between metal A and metal B, by way of resistance heating, the part of metal B, which is in contact with metal A, is molten; in a portion of a printing area, in a process of accumulating metal A, no current is applied between metal A and metal B;
or, in a portion of a printing area, in a process of accumulating metal A, a current is applied between metal A and metal B, by way of resistance heating, the part of metal B, which is in contact with metal A, has a raised temperature but is not molten; in a portion of a printing area, in a process of accumulating metal A, no current is applied between metal A and metal B;
the portion of a printing area refers to a portion of the space to be occupied by metal A and metal B in a process of printing an object.

2. The method for metal three-dimensional printing of claim 1, characterized in that
the position where metal A is in contact with metal B is controlled by a computer; and the current applied between metal A and metal B is controlled by the computer;
the object to be printed is generated by superimposing layers, namely, the object to be printed is generated through the superposition of the object layer by layer, the number of the layer or layers is at least one; each layer is composed of pixel points, and the thickness of the layer is determined by the height of the pixel points;
metal A is flowable, and whether metal A flows or not is controlled by the computer; in the printing process, metal A exists in a form of metal flow; after the front part of the metal flow is in contact with metal B and connected to metal B, the temperature of the front part of the metal flow is lowered, and the front part of the metal flow is converted into metal B automatically to form pixel points; and the number of the metal flow or metal flows is at least one.

3. The method for metal three-dimensional printing of claim 2, characterized in that
in the printing process, metal B is supported by a support layer (10), namely, the support layer (10) serves as a basis for printing the first layer;
there are some three-dimensional building steps from the first layer to the last layer as follows:
step S1, beginning to print the first layer, and under the control of the computer, metal A is in contact with a position on the support layer (10), corresponding to the first pixel point in a to-be-printed pixel queue generated by the computer of the first layer; and a bottom surface of the first layer is coplanar with an upper surface of the support layer (10);
step S2, applying or not applying a current between metal A and the support layer (10) based on parameters set by the user and/or generated by computing with the aid of the computer; if a current is applied, the intensity of the current can be controlled by the computer;
step S3, judging whether the printing of the first layer has been completed or not with the aid of the computer, if the printing of the first layer has not been completed, the position where metal A is in contact with the support layer (10) is set to be the position corresponding to the next pixel point, metal A and the support layer (10) are in contact with each other, then step S2 to step S3 are repeated; if the printing of the first layer is completed, and a next layer needs to be printed, then the printing process proceeds to step S4; if a next layer does not need to be printed, the printing process is finished;
step S4, beginning to print a new layer, under the control of the computer, metal A is in contact with a position on the layer previously built by printing, corresponding to the first pixel point in a to-be-printed pixel queue generated by the computer of the current layer; and a bottom surface of the current layer being printed is coplanar with an upper surface of the layer previously built by printing;
step S5, applying or not applying a current between metal A and metal B based on parameters set by the user and/or generated by computing with the aid of the computer; if a current is applied, the intensity of the current can be controlled by the computer;
step S6, judging whether the printing of the current layer has been completed or not with the aid of the computer, if the printing of the current layer has not been completed, the position where metal A is in contact with metal B is set to be the position corresponding to the next pixel point, metal A is in contact with metal B, then step S5 to step S6 are repeated; if the printing of the current layer has been completed and a next layer needs to be printed, then the printing process proceeds to step S7; if a next layer does not need to be printed, then the printing process is finished;
step S7, repeating step S4 to step S6 until the printing process is finished.

4. The method for metal three-dimensional printing of claim 2, characterized in that the contact manner between metal A and metal B is point dipping or dragging; in the manner of point dipping, metal A is lifted up after being in contact with and connected to metal B at a position corresponding to a pixel point, a portion of metal A is adhered with metal B and left on metal B, the other portion of metal A is separated from metal B and is in contact with metal B again when the next pixel point is printed; in the manner of dragging, in the printing process, metal A exists in a form of metal flow, in the area to be printed, the metal flow moves relative to metal B and at the same time remains in contact with metal B, after being in contact with metal B and connected to metal B, the front part of the metal flow is automatically converted into metal B, and then pixel points are formed, the subsequent metal flow is in contact with a position corresponding to a pixel point to be printed and is continuously converted into metal B, until the printing process is finished or suspended.

5. The method for metal three-dimensional printing of claim 1, characterized in that before metal A is in contact with metal B, the region of metal B, which is to be in contact with metal A, is preheated.

6. An apparatus for metal three-dimensional printing, characterized in that it comprises a heating unit used for generating molten or softened flowable metal, a position driving mechanism used for controlling the contact position between the molten or softened flowable metal and the metal built by printing, a heating current generation circuit (8) used for applying a current between the molten or softened flowable metal and the metal built by printing for realizing resistance heating, a metal raw material delivery unit, and a control unit with a computer as its core; wherein the heating unit, the position driving mechanism, the heating current generation circuit (8) and the metal raw material delivery unit are respectively connected to the control unit and are controlled by the control unit; the control unit receives files, parameters and control commands required by three-dimensional printing and input by the user; and the metal raw material delivery unit delivers the metal raw material required by three-dimensional printing into the heating unit;
the metal built by printing is referred to as metal B; and the molten or softened flowable metal generated from the heating unit is referred to as metal A.

7. The apparatus for metal three-dimensional printing of claim 6, characterized in that
the heating unit is provided with an outlet, after being heated in the heating unit, the metal raw material is output via the outlet of the heating unit to form metal A; and the number of the heating unit or heating uints is at least one;
the position driving mechanism is a multiaxial movement mechanism;
the heating current generation circuit (8) is connected to metal A and metal B; the connection state between metal A, metal B and the heating current generation circuit (8) is controlled by the control unit, and/or the working state of the heating current generation circuit (8) is controlled by the control unit;
the control unit is mainly composed of a computer, a drive circuit and a sensing circuit, wherein the computer is a general-purpose computer, or an embedded computer, or an industrial personal computer, or a hybrid computer system constituted by a general-purpose computer and an embedded computer, or a hybrid computer system constituted by an industrial personal computer and an embedded computer, or a hybrid computer system constituted by a general-purpose computer, an industrial personal computer and an embedded computer; the drive circuit drives implementation mechanisms including the heating unit, the position driving mechanism, the heating circuit generation circuit (8) and the metal raw material delivery unit, and supplies drive currents and/or drive signals to the implementation mechanisms; and the computer acquires the state information required by three-dimensional printing through the sensing circuit.

8. The apparatus for metal three-dimensional printing of claim 7, characterized in that the heating unit is mainly composed of a heating chamber (14), an electromagnetic induction coil (16) and a cap nut (15), wherein the heating chamber (14) is internally provided with a cavity, a lower part of the heating chamber (14) is provided with an outlet, an upper end of the heating chamber (14) is connected to the cap nut (15); the cap nut (15) is provided with a cooling structure used for cooling or performing heat dissipation on the cap nut (15); the cap nut (15) is provided with a through hole connected to the metal raw material delivery unit, the metal raw material delivery unit feeds the metal raw material into the heating chamber (14) via the through hole; the electromagnetic induction coil (16) is arranged on the periphery of the heating chamber (14), the electromagnetic induction coil (16) is connected to the control unit, and through the coupling effect of the electromagnetic induction coil (16), an induced current is generated in the heating chamber (14) and/or the metal raw material in the heating chamber (14) and heat is generated.

9. The apparatus for metal three-dimensional printing of claim 6, characterized in that it further comprises a protective gas delivery unit, the protective gas delivered by the protective gas delivery unit is mainly used for protecting the heated metal and/or promoting the flow of metal A; the protective gas delivery unit is controlled by the control unit; and the protective gas is originated from other systems or is produced by the protective gas delivery unit.

10. The apparatus for metal three-dimensional printing of claim 6, characterized in that it further comprises a cooling unit used for cooling a position which is influenced by a high temperature but cannot withstand it or which does not need to be heated; and the cooling unit is controlled by the control unit.

11. The apparatus for metal three-dimensional printing of claim 6, characterized in that it further comprises a build cavity (4), a process of building by printing is performed in the build cavity (4), and the build cavity (4) isolates the process of building by printing from the air.
